(19) United States
(12) Patent Application Publication
(10) Pub. No.: US 2006/0005218 A1
(43) Pub. Date: Jan. 5, 2006

(54) Dynamic content filtering of broadcast media

(76) Inventors: David A. Kroeger, Tempe, AZ (US); Louis A. Lippincott, Los Altos, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/880,756

(22) Filed: Jun. 30, 2004

(51) Int. Cl. H04N 7/16; H04N 7/025; H04N 7/10; H04N 5/445; G06F 3/00

(52) U.S. Cl. 725/28; 725/34; 725/35; 725/46

(57) ABSTRACT

One embodiment includes a method that includes receiving broadcast media that is being transmitted by a broadcast service. The method also includes dynamically filtering the broadcast media based on a frame matching between the broadcast media and a filtered content.

### TECHNICAL FIELD

The application relates generally to data processing, and, more particularly, to control capabilities for broadcast media.

### BACKGROUND

The demand for parental control capabilities for different types of broadcast media is soundly established in today's market. However, these control capabilities are typically limited for subscribers of digital broadband (such as cable or satellite). Such limited capabilities include password-enabled restrictions based on ratings (such as R, PG-13, etc.), “V-chip” content flags (such as “V” for violence, “L” for language, etc.), channel numbers and the time of day.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a block diagram of a system for dynamic content filtering of broadcast media, according to some embodiments of the invention.

FIG. 2 illustrates a more detailed block diagram of a media center for dynamic filtering of broadcast media, according to some embodiments of the invention.

FIG. 3 illustrates a flow diagram for operations to identify and to flag filtered content for dynamic content filtering of broadcast media, according to some embodiments of the invention.

FIG. 4 illustrates a flow diagram for operations to dynamically filter the content of broadcast media based on identified filtered content, according to some embodiments of the invention.

FIG. 5 illustrates a computer system used in conjunction with some embodiments of the invention.

### DETAILED DESCRIPTION

Methods, apparatus and systems for dynamic content filtering of broadcast media are described. In the following description, numerous specific details are set forth. However, it is understood that embodiments of the invention may be practiced without these specific details. In other instances, well-known circuits, structures and techniques have not been shown in detail in order not to obscure the understanding of this description. The term “media” as used herein refers to the type of content which may be broadcast to others such as mass “media” distribution of television pictures, audio, music, still pictures, etc., by any means.

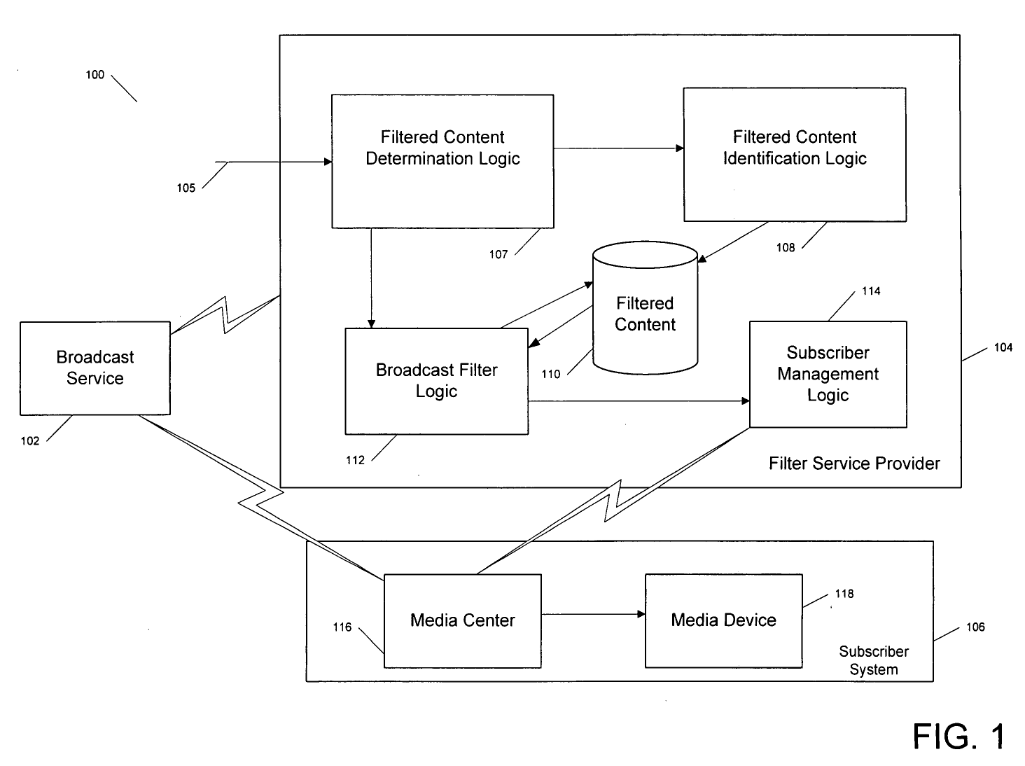

FIG. 1 illustrates a block diagram of a system for dynamic content filtering of broadcast media, according to some embodiments of the invention. In particular, FIG. 1 illustrates a system 100 that includes a broadcast service 102, a filter service provider 104 and a subscriber system 106. The filter service provider 104 includes a filtered content determination logic 107, a filtered content identification logic 108, a filtered content storage 110, a broadcast filter logic 112 and a subscriber management logic 114. The subscriber system 106 includes a media center 116 and a media (display and/or record) device 118.

The broadcast service 102 may broadcast different types of media (e.g., video, audio or a combination thereof). For example, the broadcast service 102 may be a cable television service, a satellite television service, etc. The filter service provider 104 and the subscriber system 116 may subscribe to receive the broadcast media from the broadcast service 102. The filtered content determination logic 107 and the broadcast filter logic 112 are coupled to receive the broadcast media. The media center 116 is coupled to receive the broadcast media. The filter service provider 104 may communicate with the subscriber system 106. In some embodiments, the communications between the filter service provider 104 and the subscriber system 106 is through an Internet connection (such as a broadband cable connection, a broadband Digital Subscribe Line (DSL) connection, etc.). In some embodiments, such communications may be different types of wireless communications (e.g., satellite communications, etc.). In some embodiments, such communications may be embedded within the original content signal.

The filtered content determination logic 107 may also receive a different stream of media 105. For example, in some embodiments, the different stream of media 105 may be media that was previously broadcasted. The different stream of media 105 may also be commercials from different advertisers. For example, the different stream of media 105 may be commercials provided by the different advertisers prior to such media being aired by the broadcast service 102.

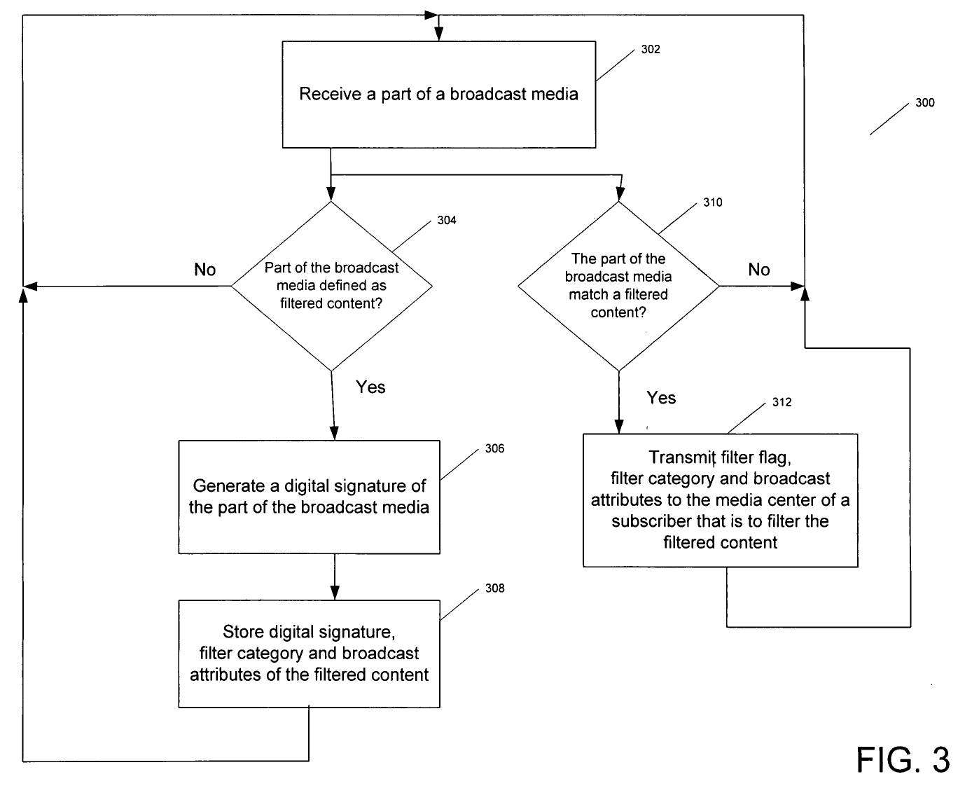

An output of the filtered content determination logic 107 is coupled to an input of the filtered content identification logic 108 and an input of the broadcast filter logic 112. An output of the filtered content identification logic 108 is coupled to an input of the filtered content storage 110. An output of the filtered content storage 110 is coupled to an input of the broadcast filter logic 112. Additionally, an output of the broadcast filter logic 112 is coupled to an input of the filtered content storage 110. An output of the broadcast filter logic 112 is coupled to an input of the subscriber management logic 114. An output of the subscriber management logic 114 is coupled to an input of the media center 116. An output of the media center 116 is coupled to an input of the media device 118. In some embodiments, the filtered content storage 110 may be volatile and/or non-volatile media (e.g., read only memory (ROM), random access memory (RAM), magnetic disk storage media, optical storage media, flash memory devices, etc.). The operations of the filter service provider 104, in accordance with some embodiments, are described in more detail below in conjunction with a flow diagram 300 in FIG. 3.

While FIG. 1 illustrates a one-to-one relationship between the filter service provider 104 and the subscriber system 106, embodiments of the invention are not so limited. For example, this relationship may be 1-to-N, N-to-1 and/or N-to-N. As further described below, in contrast to other parental control capabilities, at least some of the embodiments may filter content from commercials having content that is sexual, violent, etc. Additionally, embodiments of the invention do not censor what is being broadcast by the broadcast service 102. Rather, some embodiments filter (after receipt) of the broadcast media from the broadcast service 102 based on filter categories selected by the owners of the media devices 118.

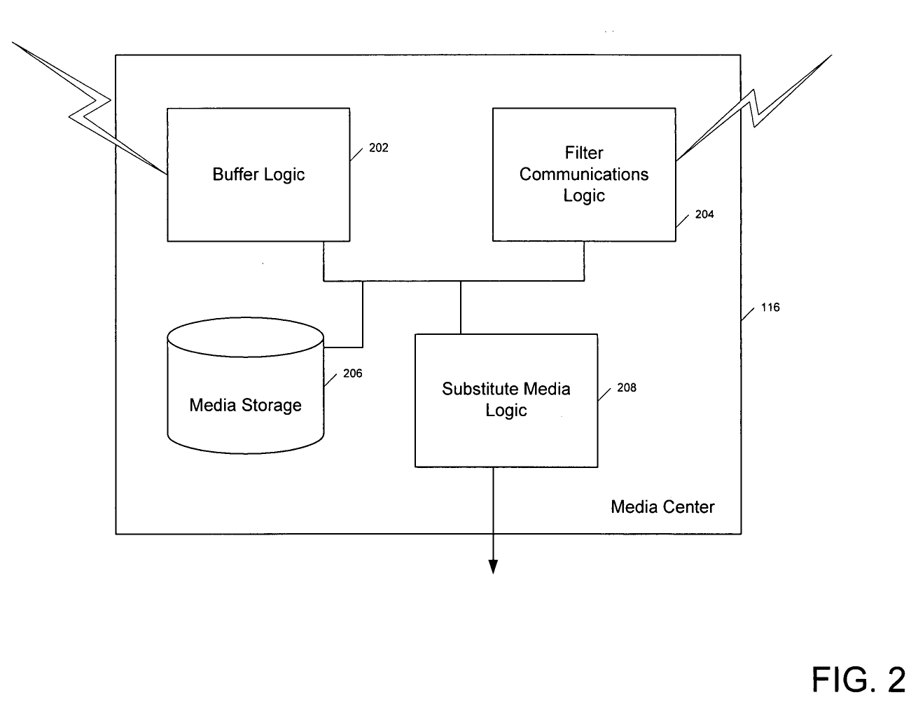

FIG. 2 illustrates a more detailed block diagram of a media center for dynamic filtering of broadcast media, according to some embodiments of the invention. In particular, FIG. 2 illustrates a more detailed block diagram of the media center 116, according to some embodiments of the invention.

The media center 116 includes a buffer logic 202, a filter communications logic 204, a media storage 206 and a substitute media logic 208, which are coupled together. The buffer logic 202 is coupled to receive the broadcast media from the broadcast service 102. The filter communications logic 204 is coupled to communicate with the subscriber management logic 114. The subscriber management logic 114 may communicate to the filter communications logic 204 filter flags, broadcast attributes and filter categories for content that is to be filtered within the broadcast media received by the media center 116. Such filter flags may be indicators that a part of the broadcast media includes content that is to be filtered (filtered content).

The subscriber management logic 114 may also communicate alternative media to the filter communications logic 204. As further described below, this alternative media may be substituted for the part of the broadcast media that is considered to be filtered content. In some embodiments, multiple streams of alternative media may be sent from the subscriber management logic 114 to the media center 116 to be stored locally for substitute display when needed without concerns regarding the receiving the alternative media because of high traffic/bandwidth limitations between the subscriber management logic 114 and the media center 116. For example, a cached queue of a number of 30 second alternative commercials may be pre-stored on the media center 116. Additionally, the subscriber management logic 114 may communicate a time delay to the filter communications logic 204. This time delay is used to determine the amount of buffering to be performed within the media center 116 in order for the filtered content to be filtered. This time delay may depend on the computational power of the filter service provider 104.

In particular, as further described below, logic within the filter service provider 104 is to determine and identify filtered content within the broadcast media being received by the broadcast service 102. Additionally, logic within the filter service provider 104 is to perform a comparison between the identified filtered content and the broadcast media received from the broadcast service 102 to determine if the broadcast media includes identified filtered content. If the broadcast media includes identified filtered content, a filter flag for such content is transmitted to the media center 116 to allow such content to be filtered from the broadcast media received from the broadcast service 102. Accordingly, such processing may require that the buffer logic 202 buffer the broadcast media in the media storage 206 so that the filtered content may be replaced prior to being received and subsequently displayed and/or recorded by the media device 118. In some embodiments, the media storage 206 may be volatile and/or non-volatile media (e.g., random access memory (RAM), magnetic disk storage media, optical storage media, flash memory devices, etc.). For example, the media storage 206 may be any of a number of different types of volatile writeable memories, such as Random Access Memory (RAM) (e.g., Synchronous Dynamic RAM (SDRAM), DRAM, DDR-SDRAM, etc.), etc.

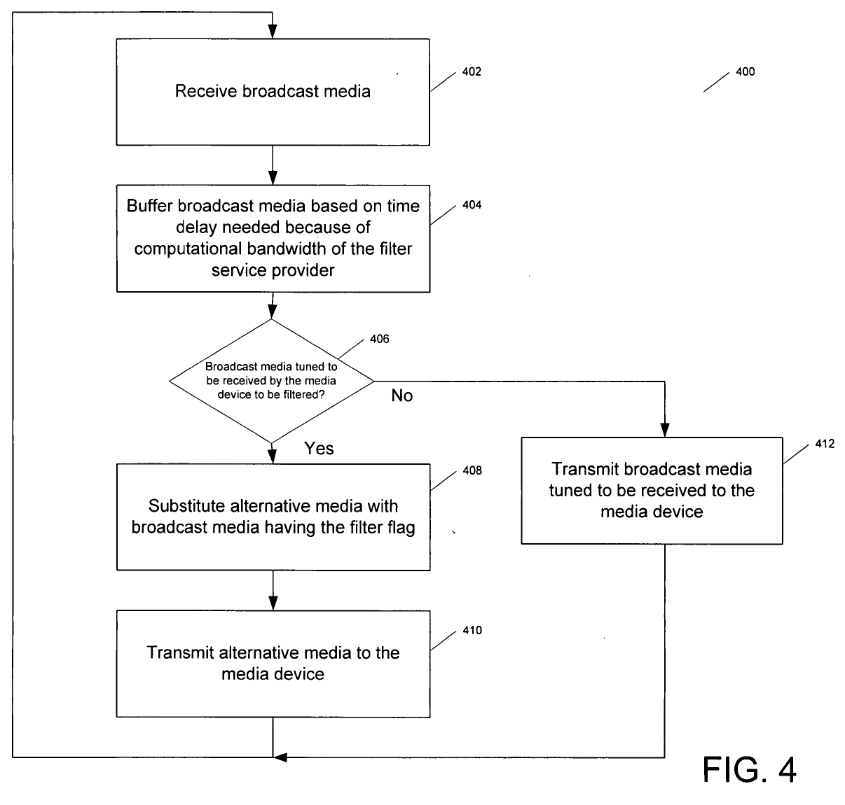

The filter communications logic 204 may communicate the viewing habits with regard to the media device 118 to the subscriber management logic 114. For example, the filter communications logic 204 may communicate the channels as well as the times of the media being received by the media device 118. As further described below, the broadcast filter logic 112 may use these viewing habits to accelerate the matching operations with regard to the filtered content. Additionally, the broadcast filter logic 112 may use these viewing habits to determine whether to filter content for given channels at given times. The operations of the subscriber system 106, in accordance with some embodiments, are described in more detail below in conjunction with a flow diagram 400 in FIG. 4.

FIG. 3 illustrates a flow diagram for operations to identify and to flag filtered content for dynamic content filtering of broadcast media, according to some embodiments of the invention. In particular, FIG. 3 illustrates the operations of the filter service provider 104, according to some embodiments of the invention.

In block 302 of the flow diagram 300, a part of the broadcast media is received. With reference to the embodiment of FIG. 1, the filtered content determination logic 107 and the broadcast filter logic 112 may receive the part of the broadcast media. The broadcast service 102 may broadcast a stream of the broadcast media. The flow diagram 300 is described such that the operations are for a part of the incoming broadcast media. The flow diagram 300 may then continue processing of the subsequent part of the broadcast media. Accordingly, depending on the communication speed at which the broadcast media is received and the computational power of the filter service provider 104, the filter service provider 104 may include a memory or other storage media (not shown) for temporary storage of the broadcast media until the logic therein may process such data. In some embodiments, the size of the part of the broadcast media may be one to N number of frames. Control continues at block 304 and block 310. In particular, the operations in blocks 304 and 310 may occur at least simultaneous in part. The operations of the block 310 are described in more detail below.

In block 304, a determination is made of whether the part of the broadcast media is defined as filtered content. With reference to the embodiment of FIG. 1, the filtered content determination logic 107 may make this determination. In some embodiments, this determination may be based on a pre-determined filtering criteria. This pre-determined filtering criteria may be provided by a separate entity (such as a filtering service) (not shown). The filter service provider 104 may be periodically updated with such criteria.

In some embodiments, the filtered content determination logic 107 may make this determination based on input from one or more operators (persons). For example, these persons may review the broadcast media as it is being broadcasted by the broadcast service 102. In some embodiments, such persons may review all of the broadcast media being broadcast by the broadcast service. In some embodiments, such persons may review less than all of such broadcast media. For example, the operators may review channels that typically broadcast a first time airing (such as a live broadcast) of a media, while not always reviewing other types of channels. To further illustrate, the operators may review certain times of days for given channels (prime time), while not reviewing other times of day (early morning). As further described below, the subscriber management logic 114 receives feedback regarding the viewing habits of the owners of the media device 118. Accordingly, the operators may selectively review certain channels and times of day based on such feedback.

Additionally, one or more operators may review the different stream of media 105 to make this determination. For example, the one or more operators may review the broadcast media (such as the commercials) for certain content that is to be filtered. Such operators may review for one or more filter categories (such as violence, language, adult content, etc.). In some embodiments, the operators may make this determination based on customer feedback. For example, if a number of customers complain about a given commercial, the operators may review the broadcast media from the different stream of media 105 to locate this commercial. In alternative embodiments, the filtered content determination logic 107 may make this determination based on matching operations (such as image and/or audio matching). For example, the pre-determined filtering criteria may be based on image matching within the video frames. For example, the image matching may relate to certain sexual or violent images. The pre-determined filtering criteria may also be based on the audio and/or closed captioning content within the broadcast media. In particular, the filtering criteria may include certain words or language, etc.

This determination may be performed on a frame-by-frame basis. In some embodiments, if at least one frame in the part of the broadcast media is defined as filtered content, all of the frames in the part of the broadcast media are defined as filtered content. In some embodiments, if a pre-determined number of frames or a percentage of frames in the part of the broadcast media are defined as filtered content, all of the frames of the part of the broadcast media are defined as filtered content. Upon determining that the part of the broadcast media is not defined as filtered content, control continues at block 302, where another part of the broadcast media is received.

In block 306, upon determining that the part of the broadcast media is defined as filtered content, a digital signature of the part of the broadcast media is generated. With reference to the embodiment of FIG. 1, the filtered content identification logic 108 may generate this digital signature. The filtered content identification logic 108 may receive the part of the broadcast media along with the time and the duration of this part of the broadcast media from the filtered content determination logic 107. The digital signature may be based on one to a number of key frames in the part of the broadcast media. The key frames may include those frames at the beginning of a scene change, the first and last frames, every other frame, every fifth frame, etc. in the part of the broadcast media. The digital signature may also include at least a part of the closed captioning content in the part of the broadcast media. For example, the part of the closed captioning content may include that content in the key frames. The digital signature may include the duration of the part of the broadcast media. For example, the digital signature may include the number of frames in the part of the broadcast media. The filtered content identification logic 108 may generate the digital signature based on an encrypted or a concatenated value of the key frames, the closed captioning content and the duration.

In some embodiments, one part of the broadcast media may be very similar to a second part of the broadcast media. For example, an advertiser may create two different commercials with a number of similarities. Accordingly, in some embodiments, the filtered content identification logic 108 may have to redefine a digital signature that is currently stored in the filtered content storage 110 if this digital signature is the same or approximately the same as another digital signature. Therefore, in some embodiments, the filtered content identification logic 108 may compare a digital signature that was generated to those digital signatures stored in the filtered content storage 110. If the generated digital signature is the same or approximately the same as another digital signature stored in the filtered content storage 110, the filtered content identification logic 108 may redefine (based on a finer granularity (e.g., more key frames)) one and/or both the digital signatures that are the same or approximately the same. Control continues at block 308.

In block 308, the digital signature, the filter category and the broadcast attributes of the filtered content are stored. With reference to the embodiment of FIG. 1, the filtered content identification logic 108 may store the digital signature, the filter category and the broadcast attributes of the filtered content into the filtered content storage 110. The filtered content may be associated with one or more filter categories. For example, filter categories may be related to violence, language, adult content (e.g., sex), etc. The broadcast attributes may include the channels and times on which the filtered content has recently aired. In some embodiments, all of the frames of the broadcast media are stored in the filtered content storage 110. Control continues at block 302, where another part of the broadcast media is received.

In block 310, a determination is made of whether the part of the broadcast media matches the filtered content. With reference to the embodiment of FIG. 1, the broadcast filter logic 112 may make this determination. In some embodiments, after receiving a first part of the broadcast media, the operations of the flow diagram 300 may include an initial delay prior to execution of the operations in block 310 to allow for the execution of the operations in the blocks 306 and 308. For example, if the filter service provider 104 is attempting to filter the broadcast media as such media is being received, an initial delay may be introduced prior to execution of the operations in block 310 to perform the operations in blocks 304-308. Such a delay allows for the storage of the digital signature, etc. of the filtered content into the filtered content storage 110 prior to this determination. Accordingly, the filter service provider 104 may filter the broadcast media as such media is being received. In some embodiments, the filtered content determination logic 107 may transmit the part of the broadcast media along with the time and the duration of this part of the broadcast media directly to the broadcast filter logic 112. In such embodiments, the broadcast filter logic 112 may filter the broadcast media based on this data received from the filtered content determination logic 107.

As part of the determination, the broadcast filter logic 112 may compare at least a part of the digital signatures of the filtered content stored in the filtered content storage 110 to the part of the broadcast media. For example, the broadcast filter logic 112 may compare the key frames of the digital signatures of the filtered content to the same frames in the part of the broadcast media. In some embodiments, the broadcast filter logic 112 may attempt to match the closed captioning content first prior to attempting to match the video and/or audio frames. Upon determining that the part of the broadcast media does not match the filtered content, control continues at block 302, where another part of the broadcast media is received.

In block 312, upon determining that the part of the broadcast media does match the filtered content, a filter flag, a filter category and broadcast attributes (for this part of the broadcast media) are transmitted to a media center of a subscriber that is to filter the filtered content. With reference to the embodiment of FIG. 1, the subscriber management logic 114 transmits the filter flag, the filter category and the broadcast attributes to the media center 116.

Additionally, the broadcast filter logic 112 may store in the entry of the filtered content (which was matched) in the filtered content storage 110 the time and/or channel on which the matching part of the broadcast media was being received from the broadcast service 102. This storage of the time and/or channel may allow subsequent matching operations to be performed faster. For example, the broadcast filter logic 112 may first search the filtered content most recently matched in the filtered content storage 110 during the matching operation in block 310. Moreover, the filtered content storage 110 may be periodically updated based on such entries. For example, if a digital signature stored therein does not have a match for a given time period (e.g., one year), such signature is deleted from the filtered content storage 110. Such cleanup operations provides may allow for faster match operations as the broadcast filter logic 112 has less digital signatures to compare against. Control continues at block 302, where another part of the broadcast media is received.

FIG. 4 illustrates a flow diagram for operations to dynamically filter the content of broadcast media based on identified filtered content, according to some embodiments of the invention. In particular, FIG. 4 illustrates the operations of the subscriber system 106, according to some embodiments of the invention.

In block 402 of the flow diagram 400, broadcast media is received. With reference to the embodiments of FIGS. 1 and 2, the buffer logic 202 may receive the broadcast media. In some embodiments, the broadcast media (transmitted by the broadcast service 102) received by the filter service provider 104 is also received by the buffer logic 202. Control continues at block 404.

In block 404, the broadcast media is buffered based on the time delay needed because of the computational power of the filter service provider. With reference to the embodiments of FIGS. 1 and 2, the buffer logic 202 may buffer the broadcast media based on the time delay needed because of the computational power of the filter service provider 104. In particular, in some embodiments, the media center 116 may delay transmission of the broadcast media to the media device 118 until the filter service provider 104 has processed the broadcast media to determine if such media included content that needs to be filtered (as described above). Control continues at block 406.

In block 406, a determination is made of whether the broadcast media tuned to be received by the media device is to be filtered. With reference to the embodiments of FIGS. 1 and 2, the substitute media logic 208 may make this determination. The media device 118 may be a television, a computer, a video cassette recorder, a digital video recorder, etc. If the media device 118 is a television or computer, the media device 118 may be tuned to receive the broadcast media for viewing thereon. If the media device 118 is a video cassette recorder or a digital video recorder, the media device 118 may be tuned to receive the broadcast media for recording thereon. In some embodiments, the tuner(s) for the media device 118 may be part of the media center 116. In some embodiments, the tuner(s) for the media device 118 may be part of the media device 118.

The substitute media logic 208 may query the tuner(s) to determine the channel of the broadcast media that is set. The substitute media logic 208 may determine whether the time and channel of the broadcast media to be transmitted to the media device 118 matches one or more of the filter flags (for the filtered content) based on the broadcast attributes. Accordingly, the substitute media logic 208 may make this determination based on the filter flag and broadcast attributes of the broadcast media (based on time and channel). Upon determining that the broadcast media tuned to be received by the media device is not be to be filtered, control continues at block 412, which is described in more detail below.

In block 408, upon determining that the broadcast media, which is tuned to be received by the media device, is to be filtered, alternative media is substituted for this broadcast media. With reference to the embodiments of FIGS. 1 and 2, the substitute media logic 208 may substitute the alternative media for the broadcast media to be filtered. The alternative media could be a number of different type of media. For example, the alternative media may be a slide show of images stored in the media center 116 and/or commercials (e.g., static images, audio, and/or video) sold by the filter service provider 104 to companies. For example, the companies may include those that are interested in targeting consumers interested in such filtering services. The alternative media may be a blank screen, a screen with a message indicating that the current broadcast media has been filtered, etc. In some embodiments, the subscriber management logic 114 may transmit the alternative media to the media center 116.

The costs of services provided by the filter service provider 104 to a subscriber may be dependent on the type of alternative media that is to be substituted. For example, the costs may be less if the alternative media is a commercial provided by the filter service provider 104 in comparison to if the alternative media are a slide show of images stored in the media center 116. Furthermore, the substitute media logic 108 may substitute for less than all of the part of the broadcast media. For example, if only the audio is within a filter category, only the audio is substituted. Control continues at block 410.

In block 410, the alternative media is transmitted to the media device. With reference to the embodiments of FIGS. 1 and 2, the substitute media logic 208 may transmit the alternative media to the media device 118. Control continues at block 402, where additional broadcast media is received.

In block 412, the broadcast media, which is tuned to be received by the media device, is transmitted to the media device. With reference to the embodiments of FIGS. 1 and 2, the substitute media logic 208 may transmit the broadcast media, which is tuned to be received by the media device 118, to the media device 118. Control continues at block 402, where additional broadcast media is received. Accordingly, as described, at least some of the embodiments of the invention may dynamically filter broadcast media as such media (marked as inappropriate) is being aired.

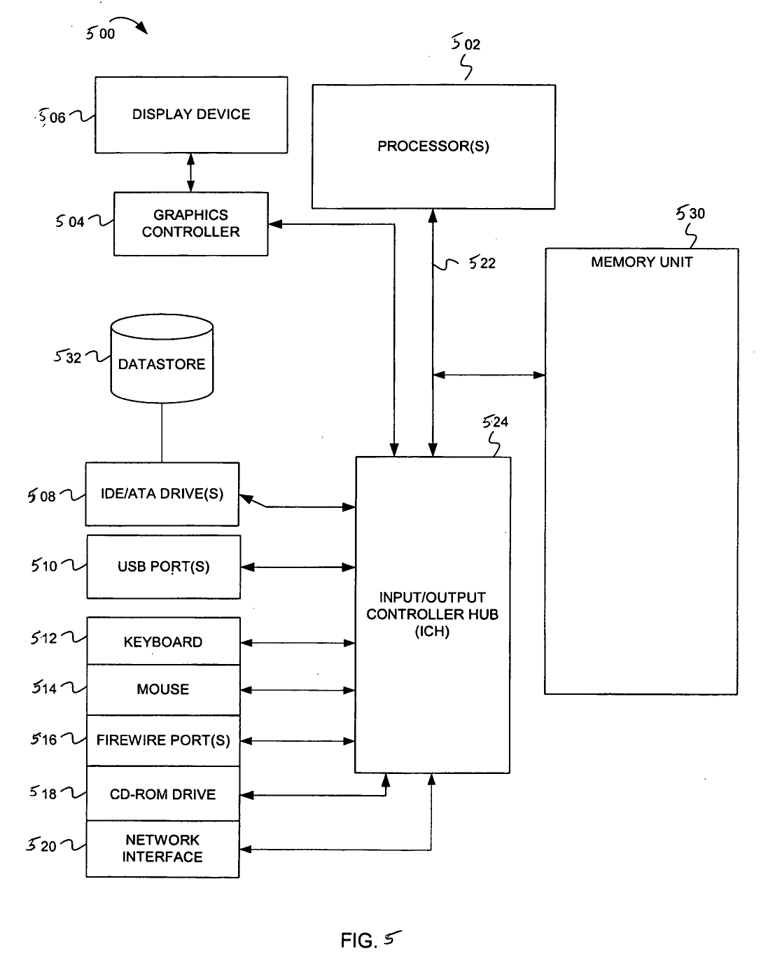

This section provides an overview of hardware and the operating environment in which some embodiments of the invention can be practiced. FIG. 5 illustrates a computer system used in conjunction with some embodiments of the invention. As illustrated in FIG. 5, a computer system 500 comprises processor(s) 02. The computer system 500 also may include a memory unit 530, a processor bus 522, and an Input/Output controller hub (ICH) 524. The processor(s) 502, the memory unit 530, and the ICH 524 are coupled to the processor bus 522. The processor(s) 502 may comprise any suitable processor architecture. The computer system 500 may comprise one, two, three, or more processors, any of which may execute a set of instructions in accordance with at least some embodiments of the invention.

In one embodiment, the computer system 500 includes a machine-readable medium that stores a set of instructions (e.g., software) embodying any one, or all, of the methodologies for dynamic content filtering of broadcast media. For example, the filtered content determination logic 107, the filtered content identification logic 108, the broadcast filter logic 112, the subscriber management logic 114, the buffer logic 202, the filter communications logic 204 and/or the substitute media logic 208 may be software.

The memory unit 530 stores data and/or instructions, and may comprise any suitable memory, such as a dynamic random access memory (DRAM), for example. The computer system 500 also may include IDE drive(s) 508 and/or other suitable storage devices. Although not shown, the memory unit 530, the processor(s) 502 and/or the IDE drive(s) 508 may include at least a part of the filtered content determination logic 107, the filtered content identification logic 108, the broadcast filter logic 112, the subscriber management logic 114, the buffer logic 202, the filter communications logic 204 and/or the substitute media logic 208. Additionally, the memory unit 530, the processor(s) 502 and/or the IDE drive(s) 508 may include the filtered content storage 110 and/or the media storage 206. A graphics controller 504 controls the display of information on a display device 506, according to some embodiments of the invention.

The input/output controller hub (ICH) 524 provides an interface to I/O devices or peripheral components for the computer system 500. The ICH 524 may comprise any suitable interface controller to provide for any suitable communication link to the processor(s) 502, the memory unit 530 and/or to any suitable device or component in communication with the ICH 524. For one embodiment, the ICH 524 provides suitable arbitration and buffering for each interface.

For some embodiments, the ICH 524 provides an interface to one or more suitable integrated drive electronics (IDE) drives 508, such as a hard disk drive (HDD) or compact disc read only memory (CD ROM) drive, or to suitable universal serial bus (USB) devices through one or more USB ports 510. For some embodiments, the ICH 524 also provides an interface to a keyboard 512, a mouse 514, a CD-ROM drive 518, one or more suitable devices through one or more firewire ports 516. For one embodiment, the ICH 524 also provides a network interface 1320 though which the computer system 500 can communicate with other computers and/or devices.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components that contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for dynamic content filtering of broadcast media, in accordance with embodiments of the invention. A number of figures show flow diagrams illustrating dynamic content filtering of broadcast media, in accordance with embodiments of the invention. The operations of the flow diagrams will be described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In view of the wide variety of permutations to the embodiments described herein, this detailed description is intended to be illustrative only, and should not be taken as limiting the scope of the invention. For example, while the system 100 is illustrated such that the media center 116 is separate from the media device 118, in some embodiments, the media center 116 may be incorporated into the media device 118. Additionally, while the system 100 is illustrated such that the components of the filter service provider 104 are separate from the subscriber system 106, in some embodiments, at least a part of the filter service provider 104 is incorporated into the subscriber system 106. For example, the operations of the broadcast filter logic 112 and the operations of the subscriber management logic 114 may be incorporated into the media center 116. Furthermore, while described such that an alternative media may be substituted for a part of the broadcast media, embodiments of the invention are not so limited. In some embodiments, the part of the broadcast media may be removed. Further, embodiments of the invention may include different types of media, including both standard definition and high definition video signals. What is claimed as the invention, therefore, is all such modifications as may come within the scope and spirit of the following claims and equivalents thereto. Therefore, the specification and drawings are to be regarded in an illustrative rather than a restrictive sense.

What is claimed is:

1. A method comprising:
receiving broadcast media that is being transmitted by a broadcast service; and
dynamically filtering the broadcast media based on a frame matching between the broadcast media and a filtered content.

2. The method of claim 1, further comprising generating the filtered content based on an attribute of the broadcast media, wherein the attribute is comprised of a key frame, closed captioning content or duration.

3. The method of claim 1, wherein dynamically filtering the broadcast media based on the frame matching between the broadcast media and the filtered content includes substituting the broadcast media to be filtered with an alternative media.

4. A method comprising:
receiving broadcast media;
comparing at least one frame of the broadcast media to at least one frame of filtered content to locate at least one frame match; and
transmitting an indication to a media center of a subscriber of the broadcast media if the frame match is located, wherein the media center is to dynamically filter the at least one frame of the broadcast media if the at least one frame is to be transmitted to a media device.

5. The method of claim 4, further comprising transmitting a time delay to the media center of the subscriber based on time of operations of the comparing.

6. The method of claim 4, further comprising transmitting an alternative broadcast media to the media center.

7. The method of claim 6, wherein the media center is to dynamically filter by substituting the alternative media for the at least one frame of the broadcast media to be filtered.

8. The method of claim 4, further comprising locating one or more frames in the broadcast media that is to be designated as the filtered content based on a filter criteria.

9. The method of claim 7, further comprising generating a digital signature of the filtered content based on one or more frames in the filtered content, closed captioning content in the filtered content or a duration of the filtered content.

10. A method comprising:
buffering the broadcast media received from a broadcast service;
receiving a filter flag and a broadcast attribute for a part of the broadcast media from a filter service provider; and
substituting the part of the broadcast media with an alternative media if the media device that is to receive the broadcast media is tuned to receive the part of the broadcast media.

11. The method of claim 10, further comprising receiving the alternative media from the filter service provider.

12. The method of claim 10, wherein buffering the broadcast media comprises buffering a number of frames of the broadcast media based on a computational power of the filter service provider.

13. A system comprising:
a broadcast filter logic to compare, based on media frame matches, broadcast media, which is being transmitted by a broadcast service, to filtered content; and
a subscriber management logic to transmit a filter flag to a subscriber of the broadcast media if the broadcast media matches the filtered content based on the comparison.

14. The system of claim 13, further comprising a filtered content determination logic to select one or more frames of the broadcast media that is to be designated as the filtered content based on a filter criteria.

15. The system of claim 14, further comprising a filtered content identification logic to identify a digital signature of the filtered content.

16. The system of claim 15, wherein the digital signature is based on one or more frames in the filtered content, a closed captioning content in the filtered content or a duration of the filtered content.

17. The system of claim 14, further comprising a filtered content database to store the filtered content, wherein the broadcast filter logic is to retrieve the filtered content from the filtered content database to compare to the broadcast media.

18. An apparatus comprising:
a Dynamic Random Access Memory (DRAM);
a buffer logic to buffer broadcast media received from a broadcast service into the DRAM;
a filter communications logic to receive a filter flag and a broadcast attribute for a part of the broadcast media from a filter service provider; and
a substitute media logic to substitute the part of the broadcast media with an alternative media, if a media device that is to receive the broadcast media is tuned to play the part of the broadcast media.

19. The apparatus of claim 18, wherein the filter communications logic is to receive the alternative media from the filter service provider.

20. The apparatus of claim 18, wherein the buffer logic is to buffer a number of frames of the broadcast that is dependent on a computational power of the filter service provider.

21. A machine-readable medium that provides instructions, which when executed by a machine, cause said machine to perform operations comprising:
receiving broadcast media that is being transmitted by a broadcast service; and
dynamically filtering the broadcast media based on a frame matching between the broadcast media and a filtered content.

22. The machine-readable medium of claim 21, further comprising generating the filtered content based on an attribute of the broadcast media, wherein the attribute is comprised of a key frame, closed captioning content or duration.

23. The machine-readable medium of claim 21, wherein dynamically filtering the broadcast media based on the frame matching between the broadcast media and the filtered content includes substituting the broadcast media to be filtered with an alternative media.

24. A machine-readable medium that provides instructions, which when executed by a machine, cause said machine to perform operations comprising:
receiving broadcast media;
comparing at least one frame of the broadcast media to at least one frame of filtered content to locate at least one frame match; and
transmitting an indication to a media center of a subscriber of the broadcast media if the frame match is located, wherein the media center is to dynamically filter the at least one frame of the broadcast media if the at least one frame is to be transmitted to a media device.

25. The machine-readable medium of claim 24, further comprising transmitting a time delay to the media center of the subscriber based on time of operations of the comparing.

26. The machine-readable medium of claim 24, further comprising transmitting an alternative broadcast media to the media center.

27. The machine-readable medium of claim 24, further comprising generating a digital signature of the filtered content based on one or more frames in the filtered content, a closed captioning content in the filtered content or a duration of the filtered content.

28. A machine-readable medium that provides instructions, which when executed by a machine, cause said machine to perform operations comprising:
buffering the broadcast media received from a broadcast service;
receiving a filter flag and a broadcast attribute for a part of the broadcast media from a filter service provider; and
substituting the part of the broadcast media with an alternative media if the media device that is to receive the broadcast media is tuned to receive the part of the broadcast media.

29. The machine-readable medium of claim 28, further comprising receiving the alternative media from the filter service provider.

30. The machine-readable medium of claim 28, wherein buffering the broadcast media comprises buffering a number of frames of the broadcast media based on a computational power of the filter service provider.
